(19) United States
(12) Patent Application Publication
(10) Pub. No.: US 2026/0341905 A1
(43) Pub. Date: Oct. 29, 2026

(54) METAL PHOSPHATES AS THE SEPARATOR COATING MATERIALS

(71) Applicant: PACIFIC INDUSTRIAL DEVELOPMENT CORPORATION, Ann Arbor, MI (US)

(72) Inventors: Bing Tan, Ann Arbor, MI (US); John Nodes, Ann Arbor, MI (US); yuhao Liao, Ann Arbor, MI (US); Luqman Azhari, Ypsilanti, MI (US)

(21) Appl. No.: 19/486,078

(22) PCT Filed: May 14, 2024
(86) PCT No.: PCT/US2024/029186

§ 371 Date: Nov. 20, 2025

Related U.S. Application Data
(60) Provisional application No. 63/469,071, filed on May 26, 2023.

(51) Int. Cl. H01M 50/451; H01M 10/0525; H01M 50/403; H01M 50/417; H01M 50/434; H01M 50/443

(52) U.S. Cl. CPC H01M 50/451; H01M 10/0525; H01M 50/403; H01M 50/417; H01M 50/434; H01M 50/443

(57) ABSTRACT

A separator for use in an electrochemical cell, such as a cell used in a secondary Li-ion battery and a method of manufacturing such a separator. The separator includes a polymeric or aramidic membrane with an inorganic material in the form of one or more metal phosphates applied in the form of a coating to at least a portion of the polymeric or aramidic membrane. The separator is positioned between the cathode and the anode, such that the separator separates the anode and a portion of the electrolyte from the cathode and the remaining portion of the electrolyte; wherein the separator is permeable to the reversible flow of ions there through.

### FIELD

This invention generally relates to a separator in an energy storage device, particularly, in a lithium-ion secondary battery. More specifically, this disclosure relates to a separator that includes one or more metal phosphates coated onto at least a portion of the separator.

### BACKGROUND

The statements in this section merely provide background information related to the present disclosure and may not constitute prior art.

Lithium ion cells have been adopted extensively for use in a variety of applications. The basic configuration of a lithium ion cell includes a positive electrode comprising a cathode and a current collector, a negative electrode comprising an anode and a current collector, a porous separator, and an electrolyte. All of these components are sealed in a case, an enclosure, a pouch, a bag, a cylindrical shell, or the like (generally called a “housing”). The cathode and the anode provide for the electron storage and release capability necessary for conducting an electrochemical reaction. The electrolyte provides a medium for metal ions (e.g., lithium ions) to be transported back and forth between the electrodes. The separator acts as an electric insulator layer located between the cathode and the anode, while permitting the lithium ions to diffuse there through.

Typically, a porous polymer thin film made from either polyethylene (PE) or polypropylene (PP) is used as the separator in a lithium-ion cell along with liquid electrolyte. Due to the limited thermal stability of polyethylene and/or polypropylene films, a ceramic coating layer having a thickness in the range of 1 micrometer (μm) to 6 μm may be applied onto the PE/PP film. A PE separator coated with a ceramic layer has shown improved thermal stability in that an uncoated polyethylene separator will shrink at a temperature of 110 °C, however, upon the application of a ceramic coating shrinkage at this temperature can be limited or curtailed. In addition to thermal stability, the application of a ceramic coating layer may also enhance the longevity or life-time of the lithium-ion cell. For example, the application of a zeolite coating can extend the cycle lifetime of a lithium ion cell by capturing any dissolved transition metal ions that may be present within the cell.

Conventional coating materials applied to PE and/or PP separators are predominantly oxide-based materials, such as aluminum oxide and Boehmite. These metal oxides, however, are limited in their ability to effectively remove both hydrogen fluoride (HF) and water from the electrolyte. When a metal oxide reacts with HF, water is generated and released. This generated water can react with the LiPF₆ salt present in the electrolyte to regenerate HF. The presence of HF is detrimental to the cycling stability of the cell since it is capable of etching the materials that form the cathode. In order to improve the cycling stability of a lithium-ion cell, it is necessary to develop other coating materials that can simultaneously remove HF and water from the electrolyte.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIGS. 1A to 1D are schematic representations in cross-sectional view of a separator containing a polymeric or aramidic membrane and a coating of an inorganic material formed according to the teachings of the present disclosure.

FIG. 2 is a schematic representation of an energy storage device comprising a separator that contains a polymeric or aramidic membrane coated with an inorganic material layer according to the teachings of the present disclosure.

FIG. 3 shows x-ray diffraction (XRD) patterns measured for various metal phosphates sintered at 750 °C according to the teachings of the present disclosure.

FIG. 4 shows x-ray diffraction (XRD) patterns measured for aluminum phosphate (AlPO₄) sintered at 350 °C, 600 °C, and 900 °C according to the teachings of the present disclosure.

FIG. 5 shows x-ray diffraction (XRD) patterns measured for barium phosphate (Ba₃(PO₄)₂) sintered at 350 °C, 600 °C, and 900 °C according to the teachings of the present disclosure.

FIG. 6 is a flow chart depicting a process for forming a separator comprising a polymeric or aramidic membrane and an inorganic material coating according to the teachings of the present disclosure.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. For example, the separators comprising one or more metal phosphate coatings applied to a polymeric or aramidic membrane made and used according to the teachings contained herein are described throughout the present disclosure in relation to a secondary cell of a lithium-ion secondary battery in order to more fully illustrate the structural elements and the use thereof. The incorporation and use of such coated separators in other applications, including without limitation, with a separator used in any electrochemical cell or in a primary cell for a lithium-ion battery, is contemplated to be within the scope of the present disclosure. It should be understood that throughout the description and drawings, corresponding reference numerals indicate like or corresponding parts and features.

The main difference between a lithium-ion battery and a lithium-ion secondary battery is that the lithium battery represents a battery that includes a primary cell and a lithium-ion secondary battery represents a battery that includes a secondary cell. The term “primary cell” refers to a battery cell that is not easily or safely rechargeable, while the term “secondary cell” refers to a battery cell that may be recharged. As used herein a “cell” refers to the basic electrochemical unit of a battery that contains the electrodes, separator, and electrolyte. In comparison, a “battery” refers to a collection of cell(s), e.g., one or more cells, and includes a housing, electrical connections, and possibly electronics for control and protection.

Since lithium-ion (e.g., primary cell) batteries are not rechargeable, their current useful life is about three years. Even with such a limited lifetime, lithium batteries can offer more in the way of capacity than lithium-ion secondary batteries. Lithium-ion batteries use lithium metal as the anode of the battery unlike lithium-ion secondary batteries that can use a number of other materials to form the anode. One key advantage of lithium-ion secondary cell batteries is that they are rechargeable several times before becoming ineffective. The ability of a lithium-ion secondary battery to undergo the charge-discharge cycle multiple times arises from the reversibility of the redox reactions that take place. Lithium-ion secondary batteries, because of their high energy density, are widely applied as the energy sources in many portable electronic devices (e.g., cell phones, laptop computers, etc.), power tools, electric vehicles, and grid energy storage.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal phosphate”, “one or more metal phosphates”, and “metal phosphate(s)” may be used interchangeably and are intended to have the same meaning.

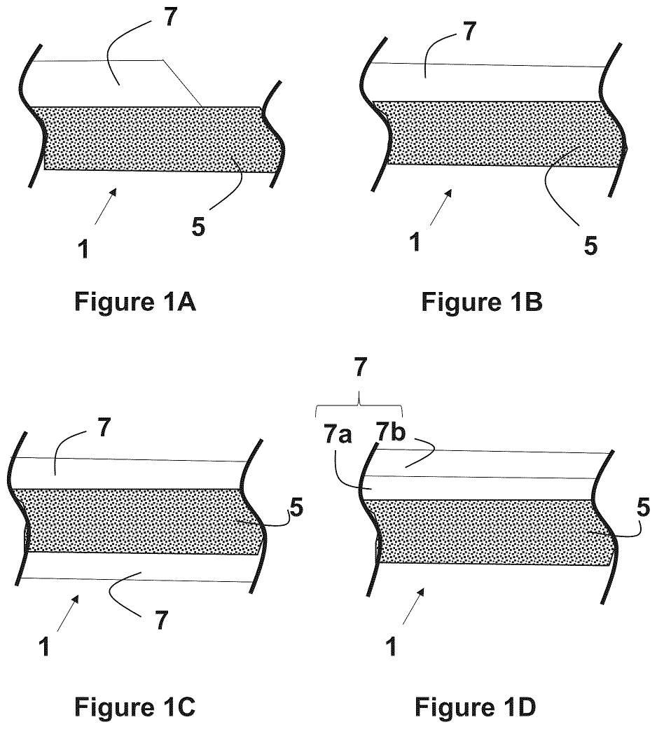

According to one aspect of the present disclosure, a separator for use in an electrochemical cell, such as an energy storage device, is provided. This electrochemical cell or energy storage device may further include a cathode as part of a positive electrode, an anode as part of a negative electrode, and a non-aqueous electrolyte. Referring to FIGS. 1A, 1B, 1C, and 1D, the separator 1 generally comprises a polymeric or aramidic membrane 5 and an inorganic material 7 comprising one or more metal phosphates. The inorganic material 7 is applied in the form of one or more coatings onto at least a portion of a surface of the polymeric membrane 5. A plurality of coating layers of the inorganic material 7 may be applied on one side of the polymeric membrane 5 as multiple layers or applied on opposite sides of the polymeric membrane 5. In FIG. 1A, the inorganic material 7 is applied as a coating to a portion of the polymeric membrane 5, while in FIG. 1B, the inorganic material 7 is applied as a coating to one entire side of the polymeric membrane 5. In FIG. 1C, the inorganic material 7 is shown applied as a coating located on both sides of the polymeric membrane 5, while in FIG. 1D, the inorganic material 7 is shown to be applied as two coating layers 7a, 7b on the same side of the polymeric membrane 5. The coating layers 7a, 7b may comprise the same metal phosphate or different metal phosphates without exceeding the scope of the present disclosure. In other words, the coating may be applied to at least a portion of a surface of the polymeric membrane; alternatively, the coating may be applied to either one side or both sides of the polymeric membrane; alternatively, at least one entire side of the polymeric membrane is coated.

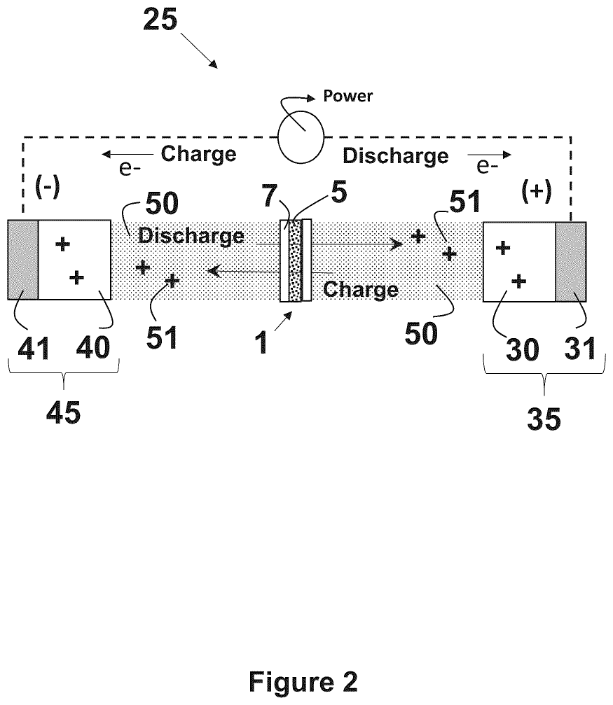

Referring now to FIG. 2, the separator 1 is shown in operation in an energy storage device 25. The separator 1 is positioned between the cathode 30 of the positive electrode 35 and the anode 40 of the negative electrode 45, such that the separator 1 separates the anode 40 and a portion of the electrolyte 50 from the cathode 30 and the remaining portion of the electrolyte 50. The separator 1 is permeable to the reversible flow of ions 51 there through. The negative 45 and positive electrodes 35 also include current collectors 41, 31 in addition to the anode 40 and the cathode 30.

The benefit of using the coated separator of the present disclosure includes, without limitation, the ability of the metal phosphate coating to simultaneously remove both hydrogen fluoride (HF) and residual water from the electrolyte, while separators containing conventional metal oxide materials, e.g., Al₂O₃ or Boehmite, are capable of only removing water. Additional benefits may include enhancement of the wettability of the membrane by the non-aqueous electrolyte, reducing the shrinkage of the membrane during operation, and/or limiting or eliminating the potential for a fire or explosion.

One skilled in the art understands that conventional polymeric or aramidic membranes are poorly wet by a non-aqueous electrolyte, thereby increasing the impedance for ion transport and resulting in a pore high-rate capability. In addition, conventional polymeric or aramidic membranes are subject to shrinkage at an elevated temperature during the operation of the electrochemical cell (e.g., secondary cell of a lithium-ion battery), thereby, increasing the risk of a short circuit and leading eventually to a possible occurrence of a fire or explosion. Furthermore, the softness of a conventional polymeric or aramidic membrane allows for the growth and penetration of dendrites, e.g., lithium dendrites, which adds to the concern for safety. Further benefits of using a separator comprising a polymeric or aramidic membrane coated with one or more metal phosphates are discussed and become evident throughout the remainder of this specification.

The metal phosphate(s) used as a coating for the separator may comprise one or more metals; alternatively, the metal phosphate is formed using one metal. The metal used in the metal phosphate(s) may be selected from the group consisting of Li, Na, K, Mg, Ca, Sr, Ba, Ti, Zr, W, Nb, Al, Si, and a combination thereof. The metal may be a metal that forms an insoluble metal fluoride in the non-aqueous electrolyte when reacting with hydrogen fluoride (HF) or hydrofluoric acid (i.e., HF in water). Alternatively, the metal in the metal phosphates may be a combination of aluminum and silicon or a combination of aluminum and barium, or a combination of aluminum and lithium, in various mass ratios.

According to one embodiment of the present disclosure, the metal phosphates comprise aluminum phosphate. The molar ratio of aluminum to phosphorous (Al:P) may be in the range of 100 to 0.01; alternatively, the ratio is in the range of 10 to 0.1; alternatively, the ratio is in the range of 2 to 0.5; alternatively, the aluminum to phosphorous ratio is about 1.

The mass of the one or more metal phosphates in the inorganic material applied as a coating to the polymeric or aramidic membrane may be in the range of about 20 wt. % to 100 wt. % relative to the total mass of the inorganic material. Alternatively, the mass of the one or metal phosphates in the inorganic material is between 50 wt. % and 100 wt. %; alternatively, in the range of 80 wt. % to 100 wt. %, relative to the overall weight or total mass of the inorganic material.

When desirable, the inorganic material applied as a coating to the polymeric or aramidic membrane may also include a binder material. This binder material may be an organic binder. The organic binder utilized in the coating formulation may comprise, without limitation, polyvinyl alcohol (PVA), polyethylene oxide (PEO), polyvinylpyrrolidone (PVP), polypropylene oxide (PPO), polyacrylic acid (PAA), carboxymethyl cellulose (CMC), sodium alginate or ammonium alginate or a combination thereof (SAA), styrene-butadiene rubber (SBR), or a mixture thereof. Alternatively, the organic binder is polyvinyl alcohol (PVA), polyethylene oxide (PEO), polypropylene oxide (PPO), or a mixture thereof.

The thickness of the coating of the inorganic material applied to the polymeric or aramidic membrane may be in the range of 0.5 micrometers (μm) to 10 μm. Alternatively, the thickness of the coating layer is in the range of about 1.0 μm to about 6 μm; alternatively, greater than or equal to 0.75 μm and less than or equal to 7.5 μm; alternatively, between about 2 μm and 5 μm; alternatively, between about 2 μm and 4 μm.

The one or more metal phosphates in the inorganic material may have an average particle size (D₅₀) that is in the range of 0.05 micrometers (μm) to 3.0 μm. Alternatively, the average particle size (D₅₀) of the metal phosphate(s) is in the range of about 0.1 μm to about 2.0 μm; alternatively, in the range of 0.2 μm to 1.5 μm; alternatively, in the range of about 0.3 μm to about 0.8 μm; alternatively, greater than 0.35 μm and less than 0.75 μm.

The BET surface area exhibited by the one or more metal phosphates is greater than or equal to 0.1 m²/g. Alternatively, the surface area is greater than or equal to 1.0 m²/g; alternatively, greater than 10 m²/g; alternatively greater than or equal to 100 m²/g; alternatively, less than 1,000 m²/g; alternatively, less than 200 m²/g.

The metal phosphate(s) that comprise the inorganic material may exhibit a crystalline structure, a semi-crystalline structure, or an amorphous structure. Alternatively, the one or more metal phosphates exhibits an amorphous structure.

When desirable, the metal phosphate(s) may be sintered at a temperature that ranges from 250 °C to 1,000 °C; alternatively, the sintering temperature may be in the range of 350 °C to 950 °C, and more preferred to be 750 °C to 900 °C. The amount of time that the metal phosphate(s) are exposed to the sintering temperature may range from minutes to hours; alternatively, greater than about 5 minutes and less than 96 hours; alternatively, between about 30 minutes and 10 hours; alternatively, in the range of 60 minutes to 5 hours.

X-ray diffraction (XRD) analysis may be used to determine the structure of the metal phosphates as being either amorphous or crystalline in nature. The average particle size and particle size distributions may be measured using any conventional technique, such as sieving, microscopy, Coulter counting, dynamic light scattering, or particle imaging analysis, to name a few. Alternatively, a laser particle analyzer is used for the determination of average particle size and its corresponding particle size distribution. The measurement of surface area for the inorganic material may be accomplished using any known technique, including without limitation, microscopy, small angle x-ray scattering, mercury porosimetry, and Brunauer, Emmett, and Teller (BET) analysis. Alternatively, the surface area is determined using Brunauer, Emmett, and Teller (BET) analysis.

The polymeric or aramidic membrane used to form the separator may comprise, without limitation, polyolefin-based materials with a semi-crystalline structure, such as polyethylene (PE), polypropylene (PP), polyimide (PI), and blends or copolymers thereof, as well as micro-porous poly(methyl methacrylate)-grafted, siloxane grafted polyethylene, and polyvinylidene fluoride (PVDF) nanofiber webs. Alternatively, the polymeric or aramidic membrane is a polyolefin, such as polyethylene, polypropylene, polyimide, or a blend or copolymer thereof.

A separator plays a significant role in the safety, durability, and high-rate performance of an electrochemical cell, such as a secondary cell for a lithium-ion battery. A polymeric or aramidic membrane is electrically insulating and separates the positive and negative electrodes completely to avoid an internal short circuit. The polymeric or aramidic membrane usually is not ionically conductive, but rather has large pores filled with the non-aqueous electrolyte, allowing for the transport of ions. Thus, the separator is porous in nature and permeable to the transport of ions there through.

According to another aspect of the present disclosure, an energy storage device, for example, a secondary cell in a lithium-ion battery, is provided. Referring once again to FIG. 2, the energy storage device 25 generally comprises a positive electrode 35, a negative electrode 45, a non-aqueous electrolyte 50 that supports the reversible flow of ions 51 between the positive electrode 35 and the negative electrode 45; and a separator 1 that includes both a polymeric or aramidic membrane and the inorganic material comprising one or more metal phosphates applied to the membrane as a coating as previously discussed above and as further defined herein.

The positive electrode 35 generally comprises an active material that acts as the cathode 30 for the cell 25 and a current collector 31 that is in contact with the cathode 30, such that the ions 51 flow from the cathode 30 to the anode 40 when the cell 25 is charging. Similarly, the negative electrode 45 comprises an active material that acts as an anode 40 for the cell 25 and a current collector 41 that is in contact with the anode 40, such that ions 51 flow from the anode 40 to the cathode 30 when the cell 25 is discharging. The contact between the cathode 30 and the current collector 31, as well as the contact between the anode 40 and the current collector 41, may be independently selected to be direct or indirect contact; alternatively, the contact between the anode 40 or cathode 30 and the corresponding current collector 41, 31 is directly made.

Still referring to FIG. 2, the active materials in the positive electrode 35 and the negative electrode 45 may be any material known to perform this function in an electrochemical cell, e.g., in a secondary cell of a lithium-ion battery. The active material used in the positive electrode 35 may include, but not be limited to lithium transition metal oxides or transition metal phosphates. Several examples of active materials that may be used in the positive electrode 35 include, without limitation, LiCoO₂, LiMn₂O₄, LiNi_{1-x-y}CoₓMn_{y}O₂ (x+y≤⅔), zLi₂MnO₃·(1-z)LiNi_{1-x-y}CoₓMn_{y}O₂ (x+y≤⅔), LiNi_{0.5}Mn_{1.5}O₁, LiFePO₄, and LiFeₓMn₁₋ₓPO₄ (0.1<x<1). Alternatively, the active material in the positive electrode 35 comprises a lithium transition metal oxide or a lithium transition metal phosphate.

The active materials used in the negative electrode 45 may include, but not be limited to graphite and Li₄Ti₅O₁₂, as well as silicon and lithium metal, hard carbon, soft carbon, silicon monoxide, Li₄Ti₅O₁₂, niobium oxide, and tungsten oxide. The current collectors 31, 41 in both the positive 35 and negative 45 electrodes may be made of any metal known in the art for use in an electrode of an electrochemical cell or lithium battery, such as for example, aluminum for the cathode and copper for the anode. The cathode 30 and anode 40 in the positive 35 and negative 45 electrodes are generally made up of two dissimilar active materials.

The non-aqueous electrolyte 50 is selected, such that it supports the oxidation/reduction process and provides a medium for ions 51 (e.g., lithium-ions) to flow between the anode 40 and cathode 30. The non-aqueous electrolyte 50 may be a solution of an inorganic salt in an organic solvent. Several specific examples of lithium salts used in the secondary cell of a lithium battery, include, without limitation, lithium hexafluorophosphate (LiPF₆), lithium bis(oxalato)-borate (LiBOB), lithium bis(fluorosulfonyl)imide (LiFSi), and lithium bis(trifluoro methane sulfonyl)imide (LiTFSi). The inorganic salts may form a solution with an organic solvent, such as, for example, ethylene carbonate (EC), ethyl methyl carbonate (EMC), diethyl carbonate (DEC), dimethyl carbonate (DMC), propylene carbonate (PC), vinylene carbonate (VC), and fluoroethylene carbonate (FEC), to name a few. A specific example of an electrolyte for use in a secondary cell of a lithium battery is a 1 molar solution of LiPF₆ in a mixture of ethylene carbonate and diethyl carbonate (EC/DEC=50/50 vol.).

Residual moisture present in a Li-ion battery may be detrimental to the life-time of a lithium-ion cell or battery. More specifically, lithium-ion secondary batteries may experience degradation in capacity due to prolonged exposure to moisture (e.g., water), hydrogen fluoride (HF), and/or dissolved transition-metal ions (TMⁿ⁺). In fact, the lifetime of a lithium-ion secondary battery can become severely limited once 20% or more of the original reversible capacity is lost or becomes irreversible. A detrimental reactions that may occur in a Li-ion battery when residual moisture is present is shown in Equation 1 below. More specifically, in a lithium-ion cell the LiPF₆ salt in the electrolyte may react with moisture to generate HF.

LiPF₆+H₂O→HF+LiF↓+H₃PO₄ (Eq. 1)

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### Electrolyte Moisture and Acidity Level

The residual moisture may arise from the electrodes or the separator, and/or be present in the electrolyte after assembly of the lithium-ion cell. Even a commercially available electrolyte, which contains <40 ppm moisture, may still be acidic and include a small amount of HF. For example, a commercially available electrolyte with a water content of <40 ppm was found to exhibit a measured pH of 4.1 (see commercial electrolyte, Table 1). When ~556 ppm water was introduced into this electrolyte, its pH was observed to decrease to 3.0, while its water content increased in to the range of 131 ppm to 181 ppm (see aged electrolyte, Table 1). This example demonstrates that part of added water has reacted with LiPF₆ to generate HF, as observed by the increase in acidity (i.e., lower pH, 4.1→3.0) and lower measured moisture level (i.e., expected to see 556+ ppm if no reaction took place). The moisture level in the aged electrolyte, however, was still much higher than the moisture level in the commercial electrolyte.

### Metal Oxide vs Metal Phosphate Effect on Moisture/Acidity.

Still referring to Table 1, when aluminum oxide was soaked in the aged electrolyte, the moisture content in the electrolyte was observed to be slightly reduced to a moisture level ranging from 77 ppm to 151 ppm (see Al₂O₃, Table 1). However, the acidity of the electrolyte was not affected (see pH=2.8, Table 1). When Boehmite was soaked in the aged electrolyte a similar result was obtained (see AlOOH, Table 1). More specifically, the moisture level was reduced to 45 ppm, but similar to the aluminum oxide, the electrolyte acidity did not decrease. A similar affect was observed upon soaking silica in the aged electrolyte (see SiO₂, Table 1). However, when a metal phosphate was soaked in the aged electrolyte, acidity of the electrolyte was observed to reduce (i.e., pH increased as compared to the aged electrolyte) along with a substantial reduction in the moisture level (see AlPO₄, Li₃PO₄, and Ba₃(PO₄)₂, Table 1).

TABLE 1
pH and Moisture Values Measured for Various Coating Materials

| Material Description | pH-adjusted | Water Content (ppm) |
|---|---|---|
| Electrolyte (commercial) | 4.1 | 38 |
| Electrolyte (aged) | 3.0 | 135-181 |
| Aluminum oxide (Al₂O₃) | 2.8 | 77-151 |
| Boehmite (AlOOH) | 2.7 | 45 |
| SiO₂ | 2.7 | N/A |
| AlPO₄-750 °C | 4.5 | 33-42 |
| Li₃PO₄-750 °C | 3.6 | 24-33 |
| Ba₃(PO₄)₂-750 °C | 3.3 | 28-39 |

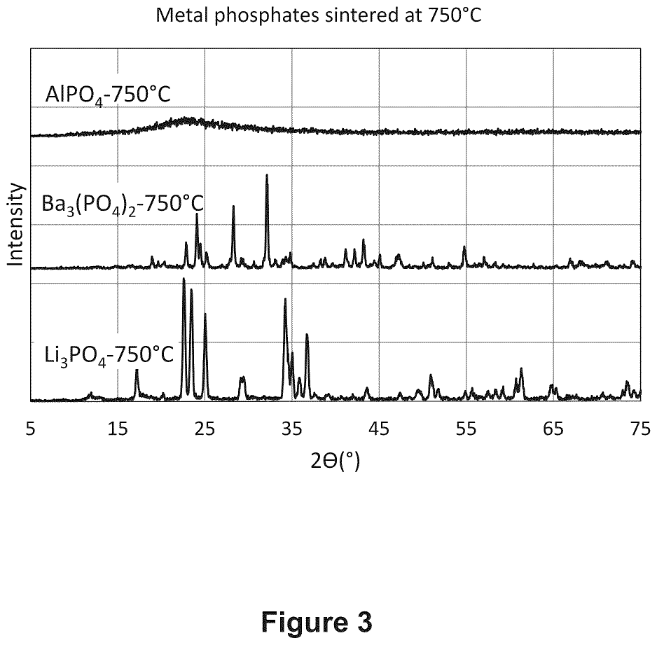

Commercially available coating materials, i.e., aluminum oxide and Boehmite, used with conventional battery separators, do not reduce the acidity of the electrolyte. In comparison, a metal phosphate is capable of effectively reducing or removing both acid(s) and moisture from the electrolyte regardless of a difference in metal ions and crystal structures. As shown in FIG. 3, aluminum phosphate calcined at 750 °C (AlPO₄-750 °C) exhibits an amorphous structure with one broad peak centered at around 23°, while both lithium phosphate (Li₃PO₄-750 °C) and barium phosphate (Ba₃(PO₄)₂-750°) C) calcined at the same temperature are highly crystalline exhibiting more than one sharp peak in the measured x-ray diffraction (XRD) pattern. Among the evaluated metal phosphates, amorphous aluminum phosphate was found to exhibit the greatest efficiency in acid removal.

Among the various metal phosphates evaluated in Table 1, AlPO₄-750 °C showed the highest pH value or the lowest acidity of the electrolyte, followed by Li₃PO₄-750 °C and Ba₃(PO₄)₂-750°) C. Regardless of their difference in crystal structures and surface areas, all of these materials showed the capability to remove both acid and moisture from the aged electrolyte, which is beneficial for improving the cycling life of a lithium-ion cell. Thus, metal phosphates are more attractive for use as a coating for a separator than the current commercial materials of aluminum oxide and Boehmite that are conventionally applied to separators. Although not wanting to be held strictly to theory, the slight differences in the acid removal ability associated with different metal phosphates may be affected by various factors including, but not limited to, the type of metal ions present, the metal/phosphate ratio, the surface area of the metal phosphate(s), and the crystal structure thereof.

### Effect of Sintering Temperature

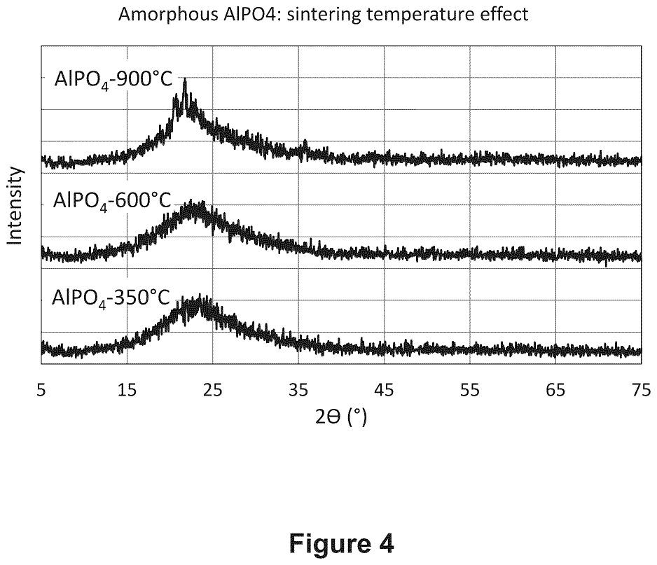

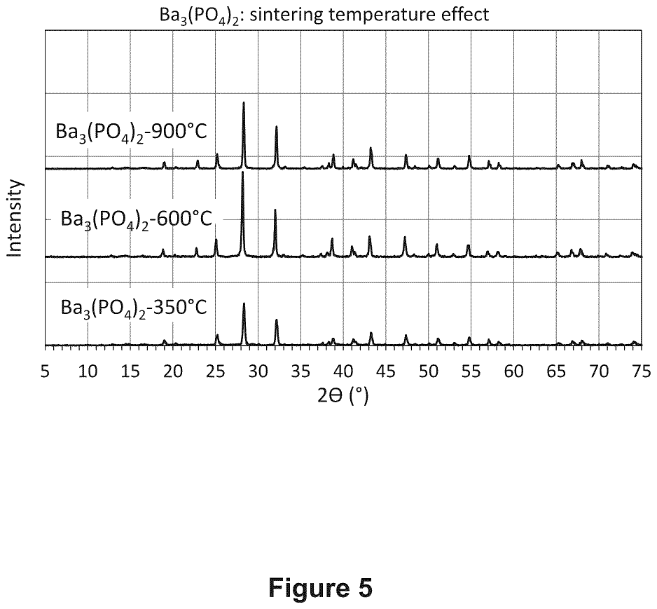

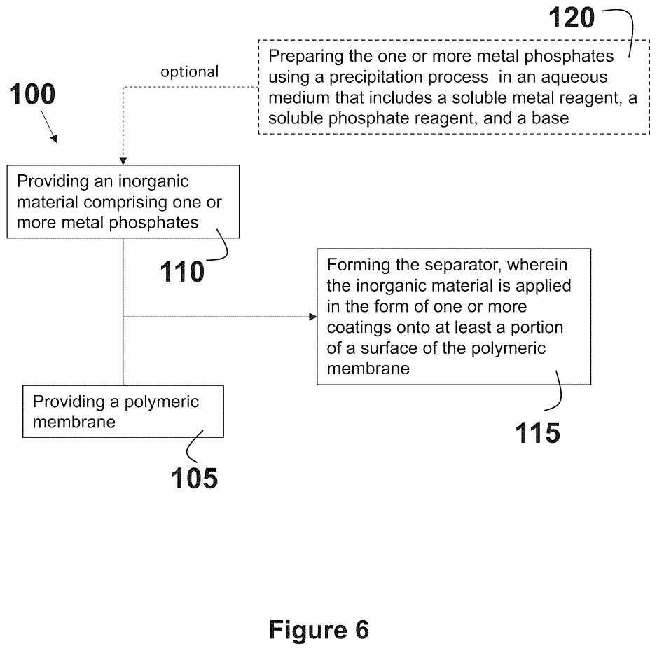

Referring now to FIGS. 5 and 6, as well as Table 2, a series of AlPO₄ samples and Ba₃(PO₄)₂ samples were sintered at temperatures of 350 °C, 600 °C, and 900 °C. These materials were characterized for their crystal structures and surface areas. The three AlPO₄ materials all exhibited amorphous crystal structures (see FIG. 4) with a relatively high surface area, i.e., >100 m²/g (see Table 2). In comparison, the three Ba₃(PO₄)₂ materials exhibited crystalline structures (see FIG. 5) with a relatively low surface area, i.e., <5 m²/g (see Table 2).

Each of the aluminum phosphate samples and the barium phosphate samples were soaked in the aged electrolyte as previously described with respect to the examples set forth in Table 1. As expected each of the AlPO₄ and Ba₃(PO₄)₂ samples were observed to absorb or remove moisture from the electrolyte (e.g., reduce water content), as well as remove HF (e.g. increased pH) as compared to the water content and pH of the aged electrolyte. In general, the pH values from the aged electrolyte containing the AlPO₄ samples were higher than those from the aged electrolyte containing the Ba₃(PO₄)₂ samples (see Table 2). Within the same composition (AlPO₄ or Ba₃(PO₄)₂)), the pH was observed to slightly increase when the sintering temperature was higher. The opposite trend was observed with respect to BET surface area (SA), e.g., the surface area decreased with respect to higher sintering temperature. This difference in the trend for the pH and the surface area demonstrates that the acid removal efficiency for a phosphate may not be determined by the surface area, but rather a higher sintering temperature could be helpful for acid removal.

TABLE 2
Moisture and pH Values from Metal Phosphate Materials

| | SA | crystal | adjusted | water |
|---|---|---|---|---|
| Coating material | (m²/g) | structure | pH | content (ppm) |
| Electrolyte (aged) | N/A | N/A | 3.0 | 135-181 |
| AlPO₄-350 °C | 188 | amorphous | 4.1-4.9 | 35-102 |
| AlPO₄-600 °C | 182 | amorphous | 4.1-4.7 | 69 |
| AlPO₄-900 °C | 147 | amorphous | 4.1-6.0 | 38 |
| Ba₃(PO₄)₂-350 °C | 4 | crystalline | 3.4 | 53 |
| Ba₃(PO₄)₂-600 °C | 4 | crystalline | 3.6 | 60 |
| Ba₃(PO₄)₂-900 °C | 2 | crystalline | 3.8 | 55 |

Referring now to FIG. 6, a method of forming a separator according to the present disclosure is provided. This method 100 comprises providing 105 a polymeric or aramidic membrane; providing 110 an inorganic material comprising one or more metal phosphates; and forming 115 a separator, wherein the inorganic material is applied in the form of one or more coatings onto at least a portion of a surface of the polymeric or aramidic membrane. The step of providing 110 an inorganic material may comprise forming 120 the one or metal phosphates using a precipitation process in an aqueous medium. This precipitation process includes the use of a soluble metal reagent, a soluble phosphate reagent, and a base. When desirable, another process could be used to form the metal phosphates, such as a solid state process, a sol-gel process, or a hydrothermal process without exceeding the scope of the present disclosure.

The soluble metal reagent may comprise, but not be limited to, a metal nitrate, a metal sulfate, a metal chloride, a metal acetate, a metal hydrate, or a mixture or combination thereof. As previously discussed above, the metal of the soluble metal reagent used to form the metal phosphate(s) may be selected from, but not limited to, Li, Na, K, Mg, Ca, Sr, Ba, Ti, Zr, W, Nb, Al, and Si. Alternatively, the soluble metal reagent may comprise one or more of Al(NO₃)₃, Al₂(SO₄)₃, AlCl₃, aluminum acetate, an aluminum hydrate, or a mixture of combination thereof.

The soluble phosphate reagent may comprise ammonium dihydrogen phosphate, diammonium hydrogen phosphate, phosphoric acid, phosphorus pentoxide, or a mixture thereof.

The base used in the precipitation process may comprise ammonia, NaOH, KOH, LiOH, tetramethylammonium hydroxide, organic amines, or a mixture thereof.

### Effect of Amorphous vs Crystalline Structure

Amorphous AlPO₄ sintered at 900 °C exhibits the greatest efficiency in removing the acid from the aged electrolyte (see Table 2). The amorphous AlPO₄ was prepared from a precipitation process using Al(NO₃)₃·9H₂O, NH₄H₂PO₄, and NH₃·H₂O as the raw materials. In order to compare the effect of crystallinity, a crystalline AlPO₄ with high surface area was prepared using a hydrothermal process. This crystalline AlPO₄ was sintered at 900 °C (see AlPO₄+HT, Table 3). The prepared amorphous aluminum phosphate (AlPO₄+HT+amine) exhibited a surface area similar to the previously described AlPO₄-900 °C amorphous material (see Table 3). However, the pH of the crystalline aluminum phosphate (AlPO₄+HT) after being soaked in the aged electrolyte was observed to be more acidic and contained a greater water content than the amorphous AlPO₄ materials (AlPO₄-900 °C or AlPO₄+HT+amine) after being soaked in the aged electrolyte (see Table 3). Thus, an amorphous AlPO₄ is preferred as the coating material for a separator over crystalline AlPO₄.

TABLE 3
Moisture and pH Values from Aluminum Phosphate Materials

| | | BET | | Water |
|---|---|---|---|---|
| | sintering | surface | adjusted | Content |
| material | temp (°C) | area (m2/g) | PH | (ppm) |
| AlPO₄-900 °C | 900 | 147 | 4.1-6.0 | 38 |
| AlPO₄-HT | 900 | 0.3 | 2.9 | 66 |
| AlPO₄-HT-amine | 900 | 147 | 3.5 | 48 |

According to another aspect of the present disclosure, one or more secondary cells may be combined to form a larger electrochemical cell, such as a lithium-ion secondary battery. A plurality of cells may be layered to form a larger single secondary cell that is encapsulated to produce the lithium-ion secondary battery. A plurality of secondary cells may also be stacked or placed in series to form a larger capacity battery with each cell being individually contained. The lithium-ion secondary batteries may also include a housing having an internal wall in which the one or more secondary cells (e.g., electrochemical cells) are enclosed or encapsulated in order to provide for both physical and environmental protection.

### General Experimental Details

Synthesis: Amorphous aluminum phosphate (AlPO₄) was prepared using a precipitation process. In this process, Al(NO₃)₃*9H₂O and NH₄H₂PO₄ were dissolved in water with stirring, followed by adding a concentrated ammonia aqueous solution (~28 wt. % NH₃). After reaching a pH ~9.0, the gel-like solution was continued to be stirred for a few hours at room temperature. The solid was collected by filtering and washing with copious amount of water. The collected powder was then dried and sintered for 4 hours at various temperatures (350 °C, 600 °C, 750 °C, 900 °C) in air. The materials are labeled as AlPO₄-350 °C, AlPO₄-600 °C, AlPO₄-750 °C, and AlPO₄-900 °C.

Crystalline AlPO₄ was prepared from a hydrothermal process. Pseudo Boehmite and phosphoric acid were mixed in water with or without di-isopropyl amine. The mixture was heated at 200 °C for 12 hours in an autoclave. After filtering and washing, the collected powder was dried and sintered at 900 °C in air for 4 hours. The prepared material without the amine was named as AlPO₄-HT. The prepared material with the amine template was named as AlPO₄-HT-amine.

Li₃PO₄-750 °C was synthesized by sintering a commercial Li₃PO₄ reagent at 750 °C in air for 4 hours.

Ba₃(PO₄)₂ samples were prepared by a precipitation process. In this process, Ba(NO₃)₂ was dissolved in water with NH₄H₂PO₄. Aqueous ammonia was added into the solution to raise the pH to about 9. The collected precipitates were washed, dried, and sintered at various temperatures (350 °C, 600 °C, 750 °C, 900 °C).

Characterization: X-ray diffraction (XRD) patterns were measured using a Rigaku X-ray diffractor. BET surface area was measured using a Micromeritics nitrogen sorption instrument.

Soaking test: In a typical test, 0.2 grams of the metal phosphate was dried under vacuum at 110 °C for 8 hours before being transferred to an inert atmosphere glove box. Inside the glove box, 2 grams of the aged electrolyte was added to the metal phosphate. The aged electrolyte was prepared by aging a mixture of 0.02 g of water and 36 grams of electrolyte (1M LiPF₆ in EC/DEC/EMC with 1/1/1 mass ratio) over 1 day. After soaking the metal phosphate in the aged electrolyte for 18 hours, the clear solution was taken out by a syringe with 200 nm filter for pH and moisture analysis. For the pH measurement, about 0.2-1.0 gram of the clear solution was added into 50 ml of 0.1 M NaCl solution under stirring. The pH of the solution was recorded after the reading was stabilized. For comparison among various coating materials, the recorded pH value was normalized as 1 gram of clear solution in 50 ml solution as the normalized pH. The moisture analysis was carried out with a Karl Fisher Titrator.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A separator for use in an energy storage device that includes a cathode; an anode; and a non-aqueous electrolyte, the separator comprising:
a polymeric or aramidic membrane; and
an inorganic material comprising one or more metal phosphates; the inorganic material being in the form of one or more coatings located on at least a portion of a surface of the polymeric or aramidic membrane;
wherein the separator is positioned between the cathode and the anode, such that the separator separates the anode and a portion of the electrolyte from the cathode and the remaining portion of the electrolyte; wherein the separator is permeable to the reversible flow of ions there through.

2. The separator according to claim 1, wherein the mass of the one or more metal phosphates is in the range of 20 wt. % to 100 wt. % relative to the total mass of the inorganic material.

3. The separator according to claim 1, wherein the separator comprises one or more of the following:
i) the mass of the one or more metal phosphates is in the range 50 wt. % to 100 wt. % relative to the total mass of the inorganic material;
ii) the one or more metal phosphates has an average particle size (D₅₀) that is in the range of 0.05 μm to 3.0 μm; and
iii) the one or more metal phosphates has a surface area that is greater than or equal to 0.1 m²/g.

4. The separator according to claim 1, wherein the thickness of the coating is in the range of 0.5 micrometers (μm) to 10 μm.

5. The separator according to claim 1, wherein the metal phosphate comprises at least one metal selected from the group consisting of Li, Na, K, Mg, Ca, Sr, Ba, Ti, Zr, W, Nb, Al, and Si.

6. The separator according to claim 1, wherein the one or more metal phosphates is aluminum phosphate.

7. The separator according to claim 1, wherein the one or more metal phosphates has an amorphous structure.

8. (canceled)

9. The separator according to claim 1, wherein the one or more metal phosphates has an average particle size (D₅₀) that is in the range of 0.1 μm to 2.0 μm.

10. (canceled)

11. The separator according to claim 1, wherein the polymeric or aramidic membrane comprises polyethylene (PE), polypropylene (PP), polyimide (PI), or a blend or copolymer thereof.

12. The separator according to claim 1, wherein the separator comprises one or more of the following:
i) the coating has a thickness in the range of 1 μm to 6 μm;
ii) the mass of the one or more metal phosphates is in the range of 80 wt. % to 100 wt. % relative to the total mass of the inorganic material;
iii) the one or more metal phosphates has an average particle size (D₅₀) that is in the range of 0.3 μm to 0.8 μm; and
iv) the one or more metal phosphates has a surface area that is greater than or equal to 100 m²/g.

13. An energy storage device comprising:
a cathode as part of a positive electrode;
an anode as part of a negative electrode;
a non-aqueous electrolyte that supports the reversible flow of ions between the positive electrode and the negative electrode; and
a separator according to claim 1.

14. The energy storage device according to claim 13, wherein the energy storage device is a secondary cell in a lithium-ion battery.

15. The energy storage device according to claim 13, wherein the positive electrode comprises a lithium transition metal oxide or a lithium transition metal phosphate; the negative electrode comprises graphite, a lithium titanium oxide, silicon metal, or lithium metal; and the non-aqueous electrolyte is a solution of a lithium salt dispersed in an organic solution.

16. A method of forming a separator according to claim 1 for use in an energy storage device, the method comprising:
providing an inorganic material comprising one or more metal phosphates;
providing a polymeric or aramidic membrane; and
forming the separator, wherein the inorganic material is applied in the form of one or more coatings onto at least a portion of a surface of the polymeric or aramidic membrane.

17. The method according to claim 16, wherein providing the inorganic material comprises preparing the one or more metal phosphates using a precipitation process in an aqueous medium that includes a soluble metal reagent, a soluble phosphate reagent, and a base.

18. The method according to claim 17, wherein the soluble metal reagent comprises a metal nitrate, metal sulfate, metal chloride, metal acetate, or a metal hydrate.

19. The method according to claim 17, wherein the soluble phosphate reagent comprises ammonium dihydrogen phosphate, diammonium hydrogen phosphate, phosphoric acid, phosphorus pentoxide, or a mixture thereof.

20. The method according to claim 17, wherein the base comprises ammonia, NaOH, KOH, LiOH, tetramethylammonium hydroxide, organic amines, or a mixture thereof.

21. The method according to claim 17 wherein the soluble metal reagent comprises one or more of Al(NO₃)₃, Al₂(SO₄)₃, AlCl₃, aluminum acetate, or a hydrate thereof.

22. The method according to claim 16, wherein the one or more metal phosphates is aluminum phosphate.
